(19) United States
(12) Patent Application Publication
(10) Pub. No.: US 2003/0134558 A1
(43) Pub. Date: Jul. 17, 2003

(54) Metallized fiber structure and its manufacturing method

(76) Inventors: Jung Shen Lien, Taipei Hsien (TW); Hung-En Chen, Jung Ho City (TW); Po-Hsiung Huang, Taipei (TW); Jun Ming Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/046,090

(22) Filed: Jan. 16, 2002

(51) Int. Cl. B32B 9/00; B32B 15/00

(52) U.S. Cl. 442/377; 427/426; 427/455; 427/456; 427/180; 428/375; 428/378; 428/379; 428/388; 428/389

(57) ABSTRACT

The present invention refers to a metalized fiber structure and its manufacturing method. It includes a metal composite to produce high electricity, heat and other related metallic functions; a fiber structure, indicating a cubic textile fabric, to provide with the main structure strength, pattern and better space, above all, to produce higher vibration absorption, buffer, breathing, warm-maintenance, grind lasting and strengthened metallized spatial effect such as electrical capacity, electromagnetic conductivity, attachment and multi-electromagnetism block; a method to attach a metal composite to a fiber structure, featuring the way to form metal particles in a vacuum lab through stimulation of certain forces, including gas bombarding thermal evaporation, plasma and electrode.

### BACKGROUND OF THE INVENTION

The present invention refers to a metallized fiber structure and its manufacturing method. Metallization indicates attaching a metallic compound through fastening aroused by energy stimulation to a fiber structure, especially a cubic structure, in a vacuum lab. Metal is an important raw material in human society. It has high electrical heat as well as strength, therefore, is generally applied in manufacturing various of domestic necessity, industrial machines, parts and products. In recent years, kinds of polymers have threatened the application of metal but failed to replace it. However, technology featuring metallic essence, such as stainless fiber fabric and electroless plating plane fabric, is brought into fashion. Stainless fiber has the advantage of the stainless pliability. It is made into different types of fabric at certain ratio by way of heat-melting, spinning and several weaving processes. It is anti-statistic, anti-microwave and electromagnetic shielded. Other than this, in the industry, the heat-enduring stainless fiber is made into heat block materials; into filtering materials due to its electrical quality. As to electroless plating plane fabric takes plane fabric as matrix and separates metallic compounds, which then attach to the matrix in the electrolyte. It is electrical conductive and able to block microwave as well as eletromagnetism. Accordingly, anti-static is a must for high-end industry and hygienic safety operation environment like electronics, electronic communication, medical therapy, food and explosion-proof etc.; microwave block or electromagnetic shield is regarded as one of the most important safety protections of human body diseases. Stainless fiber products have many useful features though, their development is severely obstructed by high cost, fiber tenacity and low mechanical nature, whereas, electroless plating plane fabric possesses better mechanical and textile texture with its matrix but it takes a lot of water laundry in the process of plating without electrolysis when it is oxidized, deoxidized and water rinsed. Doubtlessly, the great volume of water waste becomes a serious environmental pollution. Hence the demand for a highly environmental protective, low cost and well-metallized manufacturing method is anticipated. In addition, take for example the electromagnetic shield. A common plane structure apparently can't meet the need of vertical electrical conductivity, which is a better electromagnetic shield structure not only has to own high plane conductivity rate but also provides with conductivity needed for certain volume in order to increase capacity, electromagnetic dissipation and above all, multi-blockade for electromagnetic wave.

Based on the above requirements, the present invention takes fiber textile as the matrix on account of being light, thin, strong, elastic and lower cost as well. The fiber textile, featuring a spatialized cubic structure, provides other than better shock absorption and buffer, higher electrical essence and blockade. On the top of everything, the present invention utilizes a vacuum metallized manufacturing method that gathers high purity metal molecules onto the fiber structure through the sequence of gasification or ionization. Hereof, the metal molecules can be single or multiple metal composites, compounds or even chemical compounds. And the procedure of metallization can be mono or multi operation to produce one-metal or many-metal blending, cross-layer or complex, of furthermore, to promote the even distribution and production speed.

To sum up, the present invention is progressive, practical, innovative and has production value. It not only lowers cost, avoids environmental problems and most of all, increases electrical, heat and other physical properties of the products. It is a matured package ready to put into effect and effectively promotes industrial competitiveness. Unquestionably, the present invention is eligible for patent grant.

Now the features and advantages of the invention will be described in detail with reference to the accompanying drawings.

### BRIEF DESCRIPTION OF THE INVENTION

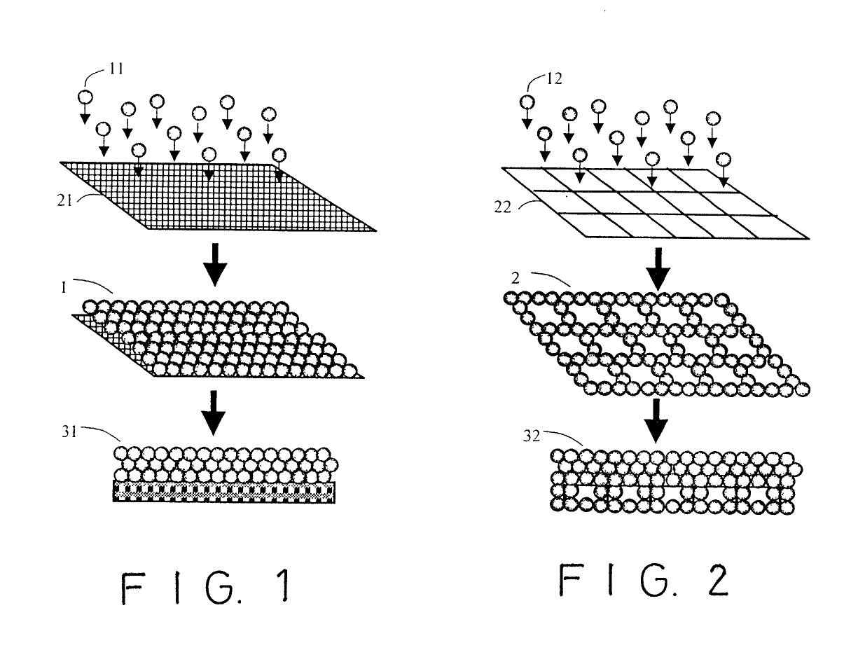

FIG. 1 is a perspective view showing the manufacturing of plane high density metallized fabric according to the invention.

FIG. 2 is a perspective view showing the manufacturing of plane web metallized fabric according to the invention.

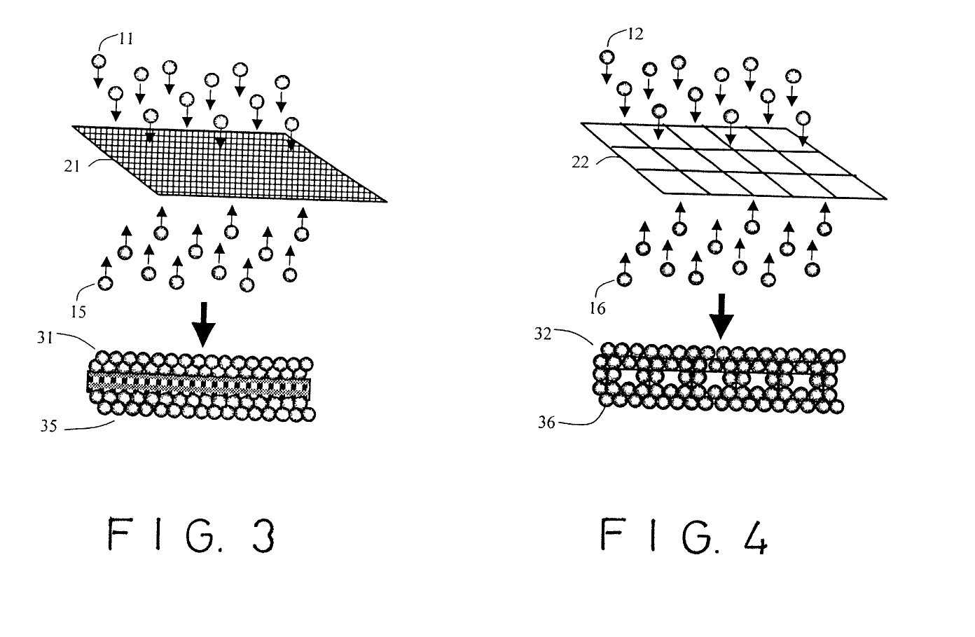

FIG. 3 is a perspective view showing the manufacturing of plane high density both-side metallized fabric according to the invention.

FIG. 4 is a perspective view showing the manufacturing of plane web both-side metallized fabric according to the invention.

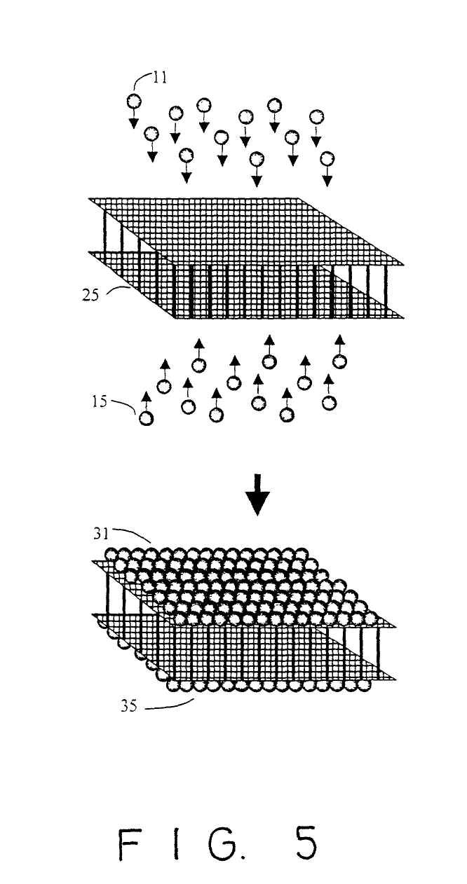

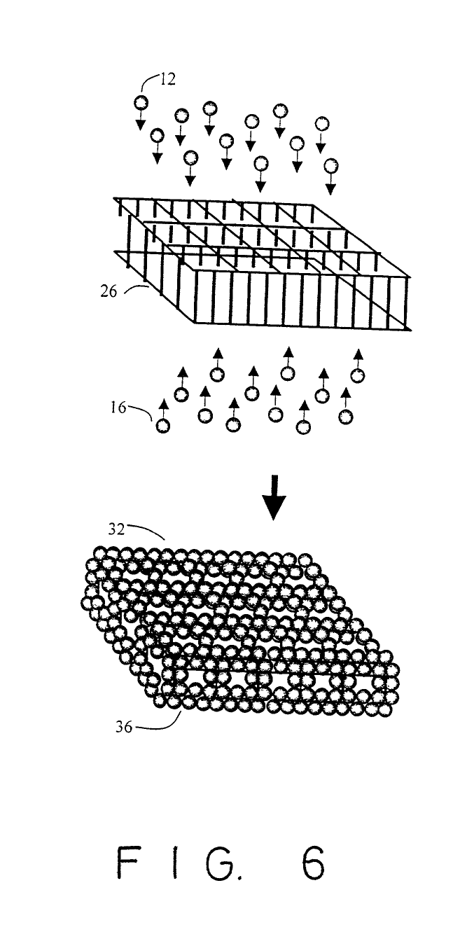

FIG. 5 is a perspective view showing the manufacturing of cubic high density both-side metallized fabric according to the invention.

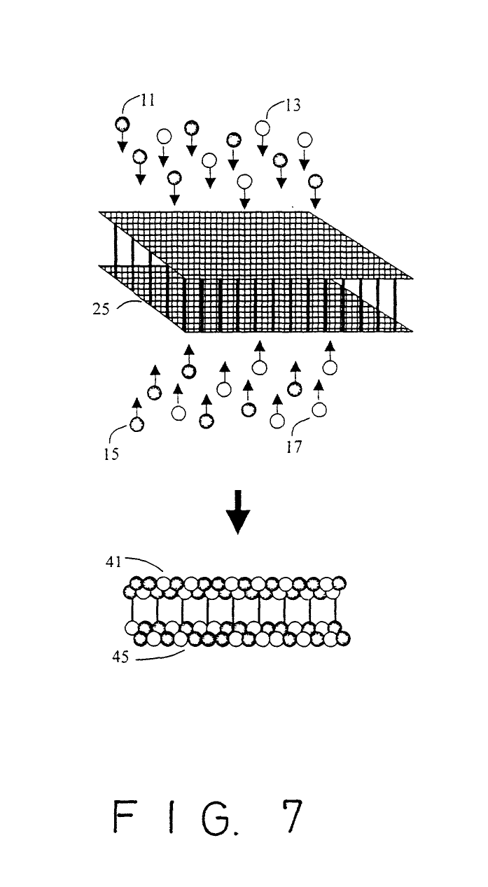

FIG. 6 is a perspective view showing the manufacturing of cubic web both-side metallized fabric according to the invention.

FIG. 7 is a perspective view showing the manufacturing of cubic high density both-side blending metallized fabric according to the invention.

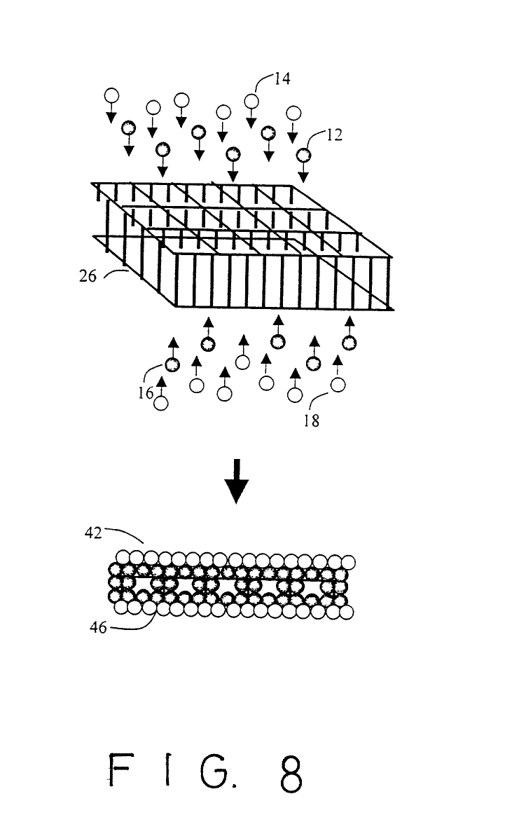

FIG. 8 is a perspective view showing the manufacturing of cubic web both-side hybrid metallized fabric according to the invention.

### DETAILED DESCRIPTION OF THE INVENTION

1. Plane high density metallized fabric manufacturing method As shown in FIG. 1, in high vacuum space, metal particles (11) are set off and dissipate in programmed direction. The matrix (21) placed on the metal particle (11) flowing routes will directly receive particle (11) anchorage and form high density metallized surface (1). Hereof, according to demands of application and design, plane high density metallized fabric can be completed by continuing or repeating the above mentioned procedure to accumulate gradually the metallized accumulation layers (31).

2. Plane web metallized fabric manufacturing method As shown in FIG. 2, in high vacuum space, metal particles (12) are set off and dissipate in programmed direction. The matrix (22) placed on the metal particle (12) flowing routes will directly receive particle (12) anchorage and form high density metallized surface (2). Hereof, according to demands of application and design, plane high density metallized fabric can be completed by continuing or repeating the above mentioned procedure to accumulate gradually the metallized accumulation layers (32).

3. Plane high density both-side metallized fabric manufacturing method As shown in FIG. 3, in high vacuum space, bilateral metal particles (11), (15) are set off and dissipate in programmed direction. The plane high density matrix (21) placed on the metal particle (11), (15) flowing routes will directly receive bilateral particle (11), (15) anchorage and form high density metallized surface. Hereof, according to demands of application and design, plane high density metallized fabric can be completed by continuing or repeating the above mentioned procedure to accumulate gradually the bilateral metallized accumulation (31), (35) layers.

4. Plane web both-side metallized fabric manufacturing method As shown in FIG. 4, in high vacuum space, bilateral metal particles (12), (16) are set off and dissipate in programmed direction. The plane web matrix (22) placed on the metal particle (12), (16) flowing routes will directly receive bilateral particle (12), (16) anchorage and form high density metallized surface. Hereof, according to demands of application and design, plane high density metallized fabric can be completed by continuing or repeating the above mentioned procedure to accumulate gradually the bilateral metallized accumulation (32), (36) layers.

5. Cubic high density both-side metallized fabric manufacturing method As shown in FIG. 5, in high vacuum space, bilateral metal particles (11), (15) are set off and dissipate in programmed direction. The cubic high density matrix (25) placed on the metal particle (11), (15) flowing routes will directly receive bilateral particle (11), (15) anchorage and form high density metallized accumulation layers (31), (35). Hereof, according to demands of application and design, cubic high density metallized fabric can be completed by continuing or repeating the above mentioned procedure to accumulate gradually thickness of the metallized accumulation layers.

6. Cubic web both-side metallized fabric manufacturing method As shown in FIG. 6, in high vacuum space, bilateral metal particles (12), (16) are set off and dissipate in programmed direction. The cubic web matrix (26) placed on the metal particle (12), (16) flowing routes will directly receive bilateral particle (12), (16) anchorage and form web metallized accumulation layers (32), (36). Hereof, according to demands of application and design, both-side cubic web metallized fabric can be completed by continuing or repeating the above mentioned procedure to accumulate gradually thickness of the web metallized accumulation layers.

7. Cubic high density both-side blending metallized fabric manufacturing method

As shown in FIG. 7, in high vacuum space, bilateral metal particles (11), (13), (15), (17) are set off simultaneously and dissipate in programmed direction. The cubic high density matrix (26) placed on the metal particle (11), (13), (15), (17) flowing routes will directly receive bilateral particle (11), (13), (15), (17) anchorage and form high density both-side blending metallized surface layers (41), (45). Hereof, according to demands of application and design, both-side cubic high density both-side blending metallized fabric can be completed by continuing or repeating the above mentioned procedure to accumulate gradually thickness of the blending metallized accumulation layers.

8. Cubic web both-side hybrid metallized fabric manufacturing method As shown in FIG. 8, in high vacuum space, bilateral metal particles (12), (16), (14), (18) are set off and dissipate in programmed direction. The cubic web matrix (26) placed on the metal particle (12), (16), (14), (18) flowing routes will directly receive bilateral particle (12), (16), (14), (18) anchorage and form web hybrid metallized surface layers (42), (46). Hereof, according to demands of application and design, both-side cubic web hybrid metallized fabric can be completed by continuing or repeating the above mentioned procedure to accumulate gradually thickness of the metallized accumulation layers.

Accordingly, the present invention includes metallized fiber structure and its manufacturing method. The structure is composed of metallic materials, such as high purity (better 99% metal contended) metal, metallic compounds or chemical compounds from copper, nickel, silver, aluminum, and fiber structure which is a textile structure, a cubic fabric especially. As to the method, it is the way to bond the metallic materials to the fiber structure. Therefore, the present invention is characteristic in

1. A metal particle formation made of high density metallic composites, compounds or chemical compounds in vacuum space under 0.1 torr through certain power agitation, herein, certain power includes gas bombarding, thermal evaporation and electrode processing.

2. A fiber structure, specially a cubic structure fabric, which can be plane sandwich fabric, web sandwich fabric, or plane web sandwich fabric. By which sandwich fabric is a cubic textile structured in three layers. The best sandwich is woven at a time and the middle linear layer is inbetween of the upper and lower layers.

3. A metallized fabric manufacturing method, in which the ingredients of metal and directions of metallization are selective and the metal particles can be made of one of many kinds of metal that either simultaneously or gradually attach to the surface of the matrix. Blending metallization forms by simultaneous attachment of more than one kind of metal, while, gradual attachment of more than one kind of metal forms hybrid metallization. When applied in two or more direction processing, products in design will be achieved.

4. The cubic matrix preferred in the present invention is composed of synthesized fiber or single spin. It is in advance demoisturized, vacuumed, surface vigorized and processed by spraying, coating or pasting in order to secure bondage of the matrix and the metallic composite.

5. The cubic matrix, with its high capacity and physical nature, can be processed by chemical plating.

6. The method can be applied to produce ceramic fiber structure and form ceramic functions by using a ceramic matrix.

As indicated, the present invention replaces metal fiber with metallized fiber, possessing electric static protection, microwave adhesion, electromagnetic wave shelter, grind endurance and metallic varnish etc. Practically and economically, it avoids environmental pollution of water and air by processing in vacuum space and lowers the related cost. The sandwich structured fabric produced not only transcends the conventional plane metallized structure in better shock absorption, buffering, breathing, thermal protection, grind endurance but also in more electrical capacity, faster magnetic conductivity with adhesion, multi-magnetic-blockade and novelty. Furthermore, the potential of variety in design by using multi-process or multi-metallization not only is versatile but technically progressive.

All in all, the present invention is exclusive and innovative. It is absolutely well-deserved your patent grant.

What is claimed is:

1. A metallized fiber structure manufacturing method producing fiber in high vacuum space by power-arousing the metal particles to attach to a fiber matrix, the power agitation being gas bombarding, thermal evaporation, plasma or plating in order to strengthen the metallized effect, such as blocking, storing and conducting electricity, magnetic wave and thermal energy, on the metallized fiber structure.

2. The metallized fiber structure manufacturing method, as mentioned in claim 1, wherein using high metal contended composites, compounds or chemical compounds that are composed of one or more kind of metallic materials like copper, nickel, silver, or aluminum, by blending, hybrid or compounding.

3. The metallized fiber structure manufacturing method, as mentioned in claim 1, wherein manufacturing fabric in vacuum air being under 0.1 torr.

4. The metallized fiber structure manufacturing method, as mentioned in claim 1, wherein to utilize sandwich structured matrix whose three layers are woven at a time and among which the linear middle layer is preferred. The upper and lower layers can be either plane cubic structure or web cubic structure.

5. The metallized fiber structure manufacturing method, as mentioned in claim 1, wherein that using matrix that is in advance polymer sprayed, coated and pasted to secure the bondage of the matrix and metal particles.

6. The metallized fiber structure manufacturing method, as mentioned in claim 1, wherein to use chemical plating to metallize the fabric.

7. The metallized fiber structure manufacturing method, as mentioned in claim 1, wherein that using matrix composed of synthetic fiber or single spin.

8. The metallized fiber structure manufacturing method, as mentioned in claim 1, wherein to program the direction of metallization according to the direction of power agitation, while the metal particles being made of one or more kind of metal simultaneously or gradually to form blending, hybrid or compounding metallic functions or to promote even distribution of metallization and accelerate production.

9. The metallized fiber structure manufacturing method, as mentioned in claim 1, wherein that using metal particles separated by gasification and ionization hence gathered up on the surface of the matrix, and the metal particles being single or more metallic materials, compounds or chemical compounds.

10. The metallized fiber structure manufacturing method, as mentioned in claim 1, that using chemical plating to produce metallized fiber structure whose characteristic is utilizing cubic structure textile as the matrix.

11. The metallized fiber structure manufacturing method, as mentioned in claim 1, that producing ceramicallized fiber structure by substituting ceramic composite for metallic composite.

12. A metallized fiber structure including a textile matrix which is either a single spinning fiber composite or a cubic fiber structure and whose surface is covered up with metal particle layers to form metallized fiber structure.

13. The metallized fiber structure, as mentioned in claim 12, wherein the matrix being one-side or both-side metal particle anchored.

14. The metallized fiber structure, as mentioned in claim 12, wherein the matrix is plane.

15. The metallized fiber structure, as mentioned in claim 12, wherein the matrix is plane web.

16. The metallized fiber structure, as mentioned in claim 12, wherein the matrix is cubic high density.

17. The metallized fiber structure, as mentioned in claim 12, wherein the matrix is cubic web.
